(19) United States
(12) Patent Application Publication
(10) Pub. No.: US 2009/0229738 A1
(43) Pub. Date: Sep. 17, 2009

(54) Method and apparatus for manufacturing layered articles made of elastomeric material

(76) Inventors: Gaetano Lo Presti, Milano (IT); Rodolfo Noto, Milano (IT); Giovanni Pozzati, Milano (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/665,836

(22) PCT Filed: Oct. 11, 2005
(86) PCT No.: PCT/IB2005/053345

§ 371 Date: Oct. 24, 2008

(30) Foreign Application Priority Data
Oct. 27, 2004 (IT) PCT/IT2004/000592
Dec. 7, 2004 (IT) PCT/IT2004/000680

(51) Int. Cl. B29D 30/08

(52) U.S. Cl. 156/117; 156/397

(57) ABSTRACT

During manufacture of a tyre for motor vehicles, one or more structural elements of elastomeric material, such as a tread band provided with a respective under-layer, are manufactured by laying a continuous elongated element on the carcass structure or other forming support, which elongated element is longitudinally divided into a first and second mutually-coupled portions that are obtained through extrusion of two different elastomeric materials coming from respective extruders leading to a common extrusion die. Laying of the coils takes place in such a manner that the first and second materials form a first layer and a second layer overlapping the first layer, respectively.

The present invention relates to a method of manufacturing layered articles of elastomeric material.

The invention also relates to an apparatus for manufacturing layered articles of elastomeric material, following the above mentioned method.

During the present description the invention will be set out making specific reference to the manufacture of tyres for vehicle wheels. This does not exclude the possibility of manufacturing other different articles such as vulcanisation bladders used in tyre manufacturing processes, expandable bags used in tyre manufacturing apparatus, or still others.

A tyre for vehicle wheels generally comprises a carcass structure including at least one carcass ply made up of reinforcing cords incorporated in an elastomer matrix. The carcass ply has end flaps respectively engaged with annular reinforcing structures located in the regions usually identified as “beads” and each normally formed of a substantially circumferential annular insert onto which at least one filling insert is applied, at a radially external position.

Associated with the carcass ply at a radially external position is a belt structure comprising one or more belt layers disposed in radial superposed relationship with each other and having textile or metallic reinforcing cords with a crossed orientation and/or substantially parallel to the circumferential extension direction of the tyre. A tread band also made of elastomer material as other structural elements constituting the tyre, is applied to the belt structure, at a radially external position.

A so-called “under-layer” can be interposed between the tread band and the belt structure, said under-layer being made of elastomeric material having properties adapted to ensure a steady union of the tread band.

It is to be pointed out that to the aims of the present description with the term “elastomeric material” it is intended a composition comprising at least one elastomeric polymer and at least one reinforcing filler. Preferably, this composition further comprises additives such as a cross-linking agent and/or a plasticizer. Due to the presence of the cross-linking agent, this material can be cross-linked through heating so as to form the final article.

Respective sidewalls of elastomeric material are also applied to the side surfaces of the carcass structure, each extending from one of the side edges of the tread band until close to the respective annular anchoring structure to the beads.

In tyres of the tubeless type the carcass ply is fully coated with a layer of a preferably butyl-based elastomeric material usually referred to as “liner” having optimal airtightness features and extending from one of the beads to the other.

In tyres of the run flat type or for other particular uses, the carcass structure can further be provided with auxiliary support inserts of elastomeric material, located at an axially internal position to each of the sidewalls. These auxiliary support inserts usually called “sidewall inserts”, lend themselves to support the loads transmitted to the wheel in case of accidental deflation of the tyre, to enable the vehicle to go on running under safety conditions.

In many known processes for manufacturing a tyre the carcass structure and belt structure, as well as the tread band, sidewalls and any other structural element of elastomeric material, are made separately from each other in respective work stations, and then stowed in storage stations or magazines from which they are subsequently picked up for mutual-assembly purposes along a tyre manufacturing line.

Also recently developed have been production processes in which, as described in WO 01/36185 in the name of the same Applicant for example, the structural elements of the tyre are built on a suitably shaped forming support, by sequentially laying on the latter, a plurality of elementary components consisting of single rubberised cords or cords grouped together in parallel side by side relationship to form narrow strips for example, that are particularly used in the manufacture of the carcass and belt structures, and of continuous elongated elements of elastomeric material, particularly used for manufacturing other structural elements of the tyre such as tread band, sidewalls, liner, fillers, auxiliary support inserts. More specifically, a robotized arm bears a toroidal support on which each of the structural elements of a tyre under production is directly made. The robotized arm gives the toroidal support a circumferential-distribution motion around the geometric axis thereof, simultaneously with controlled displacements of transverse distribution in front of a delivery member supplying a continuous elongated element of elastomeric material. The continuous elongated element therefore forms a plurality of coils the orientation and mutual-superposition parameters of which are treated so as to control the thickness variations to be given to a structural element of a tyre being manufactured, based on a predetermined laying-down scheme pre-set in an electronic computer.

GB 1,048,241 teaches how to directly wind up on a tyre being manufactured, a continuous elongated element directly coming from an extruder so as to form coils disposed in axial side by side and/or radial superposition relationship in order to obtain the tread band. The tread band is directly made on the carcass sleeve of a cylindrical shape disposed on the building drum before the sleeve itself is shaped into a toroidal conformation.

In document WO 2004-041522, also in the name of the same Applicant, the carcass structure and belt structure of a tyre being manufactured are made through assembling of semi-finished structural elements on a building drum and an auxiliary drum respectively, while some other structural elements of elastomeric material, in particular the tread band, under-layer and/or sidewalls, are made through spiralling of a continuous elongated element produced by an extruder, directly onto the carcass and/or belt structures.

The applicant has encountered difficulties in obtaining under-layers or other structural elements of limited thickness through spiralling of a continuous elongated element directly coming from an extruder. Actually, to enable the continuous elongated element to have a sufficient structural consistency for subsequent handling and to be extruded with the necessary regularity, the thickness of said element is required not to be under given values. Extrusion of a continuous elongated element of a small thickness in addition would impose important restrictions to the exit speed of the element itself from the extrusion die, with possible productivity drops.

The applicant has also perceived that if the under-layer and tread band are made in two distinct work stations by means of said continuous elongated element, it is not possible to fully exploit the production capacities of the installation designed for tyre manufacture.

In spite of the above listed problems relating to said restrictions in the exit speed of the continuous elongated element from the extrusion die, the Applicant has however ascertained that manufacture of the under-layer is tendentially completed in greatly shorter times than those required for manufacturing the tread band having a much greater thickness than that of the under-layer. Consequently, the work station dedicated to manufacture of the under-layer is necessarily submitted to important stand-by times between working of two tyres in succession, to enable the work station dedicated to manufacture of the tread band to complete working.

In accordance with the present invention, the Applicant has perceived that if the material designed to form the under-layer (or other relatively thin structural element) is coupled with at least part of the material designed to form the tread band (or other structural element to be manufactured adjacent to the thin element) before carrying out spiralling, a continuous elongated element of a suitable structural consistency can be obtained which is adapted to, for example, give a very thin under-layer simultaneously with part of the tread band.

The Applicant has therefore found that by preparing a continuous elongated element through co-extrusion of a first and a second elastomeric materials, and spiralling said element so as to obtain a layered component on the forming support, the productivity can also be increased in the manufacture of very thin structural elements and, in case of need, a better distribution can be obtained as regards the working time required from different work stations co-operating in producing the tyre.

In the present specification and in the following claims, by “layered component” it is intended a structural tyre element or a portion thereof.

Within the present definition, by “structural element” of the tyre it is intended any part made of elastomeric material such as the tread band, sidewalls, auxiliary support inserts, fillers, liner and/or under-liner, or a portion thereof, or also the assembly formed of two or more of said parts or portions.

In the present specification and in the following claims, by “layered element” it is intended an article of manufacture different from a tyre or from a structural element thereof, such as a vulcanisation bladder, an expandable bag and the like, or a portion of same.

In more detail, the invention relates to a method of manufacturing a tyre for vehicle wheels, comprising the steps of: forming a carcass structure comprising elongated reinforcing elements incorporated in an elastomer matrix; associating structural elements of elastomeric material with said carcass structure; wherein the step of associating structural elements of elastomeric material with the carcass structure comprises preparation of at least one layered component through the steps of: conveying a first and a second elastomeric materials to an extrusion die; coupling the first and second elastomeric materials through said extrusion die, to deliver a first continuous elongated element defined by a first longitudinal portion and a second longitudinal portion disposed side by side and respectively made up of said first and second elastomeric materials; laying said continuous elongated element on a forming support by means of coils wound up according to a predetermined path so as to form said layered component consisting of a first layer and a second layer made by said first and second elastomeric materials, respectively; curing the tyre.

In accordance with a further aspect, it is an object of the invention to provide an apparatus for manufacturing tyres of vehicle wheels comprising: devices designed to form a carcass structure comprising elongated reinforcing elements incorporated in an elastomer matrix, devices for associating structural elements of elastomeric material with said carcass structure; devices for curing said tyre, wherein the devices for associating the structural elements of elastomeric material with the carcass structure comprise at least one unit for manufacturing layered components, comprising: first devices for feeding a first elastomeric material; second devices for feeding a second elastomeric material; an extrusion die communicating with said first and second feeding devices to deliver a first continuous elongated element defined by a first longitudinal portion and a second longitudinal portion disposed close to each other and made up of said first and second elastomeric materials, respectively; members for laying said continuous elongated element on a forming support in the form of coils wound up following a predetermined path, so as to obtain a layered component having a first layer and a second layer consisting of said first and second elastomeric materials, respectively.

Further features and advantages will become more apparent from the de-ailed description of a preferred but not exclusive embodiment of a method and an apparatus for manufacturing tyres for vehicle wheels or other articles of elastomeric material, in accordance with the present invention.

This description will be set out hereinafter with reference to the accompanying drawings, given by way of non-limiting example, in which:

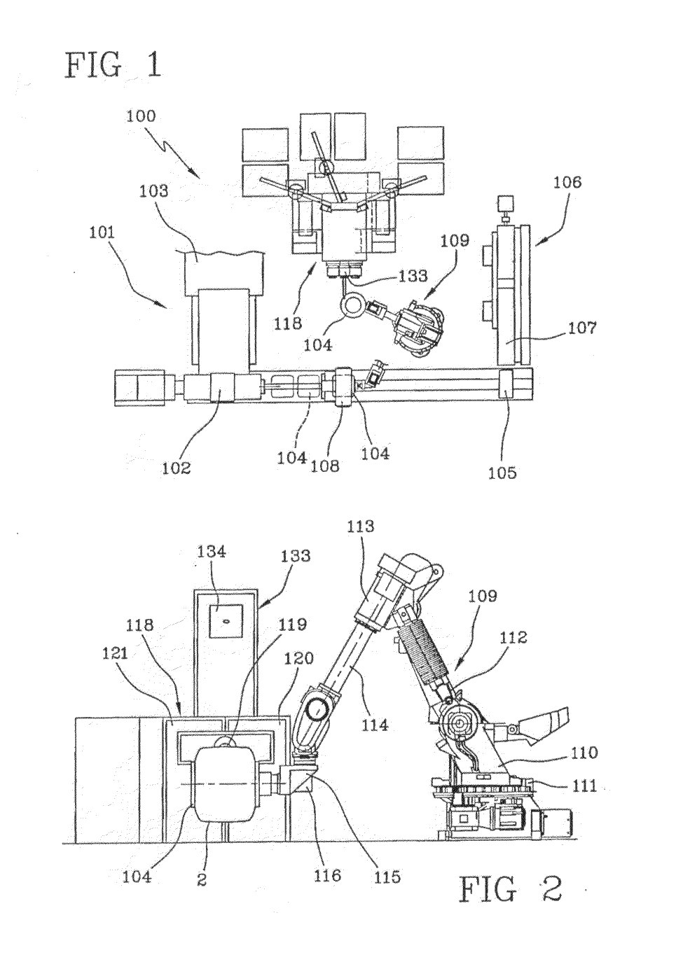

FIG. 1 is a diagrammatic top view of an apparatus for manufacturing tyres in accordance with the present invention;

FIG. 2 is an elevation view of a portion of the apparatus shown in FIG. 1;

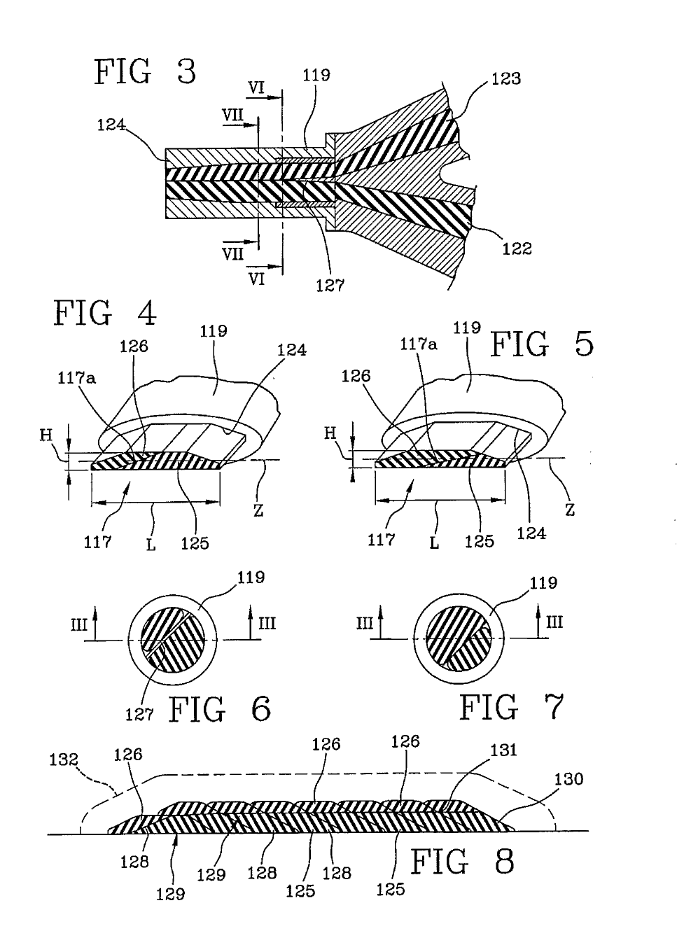

FIG. 3 shows a detail of an extrusion die, sectioned along a diametral plane identified with III-III in FIGS. 6 and 7;

FIG. 4 is a fragmentary perspective view in a cross section plane of a continuous elongated element emerging from the extrusion die;

FIG. 5 is a fragmentary perspective view in a cross section plane of a further example of a continuous elongated element obtainable in accordance with the invention;

FIG. 6 shows a section taken along line VI-VI in FIG. 3, during extrusion of a continuous elongated element as seen in FIG. 4;

FIG. 7 shows a section taken along line VII-VII in FIG. 3, during extrusion of a continuous elongated element as seen in FIG. 5;

FIG. 8 is a laying-down scheme given by way of example, of the continuous elongated element seen in FIG. 4, in the form of coils disposed close to each other, in order to obtain a layered component;

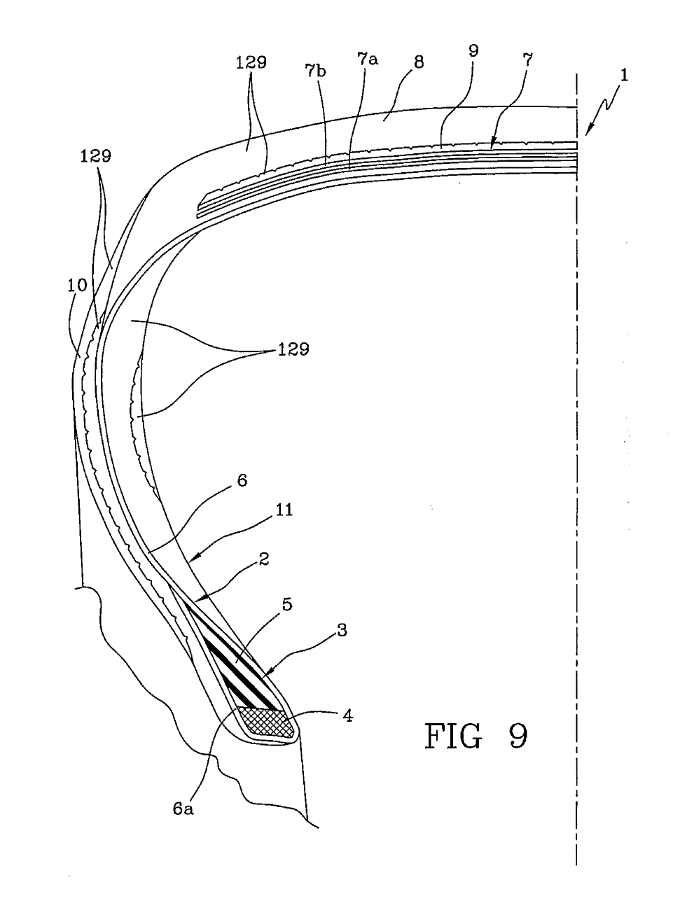

FIG. 9 is a fragmentary diagrammatic cross-section view of a tyre obtainable in accordance with the present invention.

Referring particularly to FIGS. 1 and 2, an apparatus for manufacturing tyres for vehicle wheels designed to put into practice a manufacturing method in accordance with the present invention has been generally identified with reference numeral 100.

In the embodiment shown, apparatus 100 is set for manufacturing tyres of the type shown by way of example in FIG. 9 and generally denoted at 1. Tyre 1 essentially comprises a carcass structure 2 of substantially toroidal conformation comprising cords or other elongated reinforcing elements incorporated in an elastomer matrix, and structural elements of elastomeric material 5, 8, 9, 10, 11 associated with the carcass structure 2, as better described in the following.

In more detail, the carcass structure 2 may for example comprises a pair of annular anchoring structures 3 integrated into the regions usually identified as “beads”; each consisting of at least one substantially circumferential annular insert 4, usually called “bead core”, formed of one or more rubberised cords or equivalent elongated reinforcing elements incorporated in an elastomer matrix. An elastomeric filling 5 can be applied to the bead ring 4 at a radially external position. In engagement with each of the annular anchoring structures 3 are the end flaps 6a of at least one carcass ply 6 comprising textile or metallic rubberised cords, or equivalent elongated reinforcing elements incorporated in an elastomer matrix and extending transversely of the circumferential extension of tyre 2, possibly with a predetermined inclination, from one of the annular anchoring structures 3 to the other.

In tyres of the tubeless type, i.e. without an air tube, the carcass structure 2 at a radially internal position is provided with a layer of a substantially airtight elastomeric material generally referred to as “liner” and not shown.

Usually associated with the carcass structure 2 is also one or more belt layers 7a, 7b comprising metallic or textile rubberised cords or equivalent elongated reinforcing elements incorporated in an elastomer matrix, suitably inclined relative to the circumferential extension of the tyre according to preferably crossed orientations between one belt layer and the other, as well as a possible outer belting layer (not shown) comprising one or more cords circumferentially wound into coils disposed axially in side by side relationship around the belt layers 7a, 7b. The assembly consisting of the belt layers 7a, 7b and the possible outer belting layer defines a so-called belt structure generally denoted at 7, of a substantially cylindrical annular conformation, applied at a radially external position around the carcass structure 2. To the aims of the present specification and the following claims, the belt structure 7, while described as a distinct component, is considered (when not otherwise expressly stated) to be an integral part of the carcass structure 2.

Further associated with the carcass structure 2 is a tread band 8 circumferentially applied to the belt structure 7 at a radially external position, after possible interposition of a so-called “under-layer” 9 formed of a thin layer of elastomeric material having suitable composition and physico-chemical features and acting as an interface between the true tread band and the underlying belt structure 7. A pair of sidewalls 10 is laterally applied to the carcass structure 2 at respectively opposite sides.

In run flat tyres or tyres intended for particular uses, auxiliary support inserts 11 may be also provided, of the type usually referred to as “sidewall inserts” for example, that are applied to the region close to the sidewalls 10 internally of the carcass ply 6, as shown by way of example in FIG. 1, or between two paired carcass plies or also at a position radially external to the carcass structure 2.

Tyre 1 lends itself to be obtained using a manufacturing apparatus 100 essentially comprising devices designed to form the carcass structure 2 and devices for carrying out association of the carcass structure 2 with the tread band 8, sidewalls 10, possible auxiliary support inserts 11, said liner and/or other structural elements of elastomeric material co-operating in forming tyre 1.

The individual components of the carcass structure 2 and the belt structure 7 such as in particular the annular anchoring structures 3, carcass ply or plies 6, belt layers 7a, 7b and further possible reinforcements designed to constitute the outer belting layer, can be supplied to apparatus 100 in the form of semi-finished products, made in preceding working steps, to be suitably assembled with each other.

In this case, the devices for making the carcass structure 2 can usually comprise a manufacturing line 101, not described in detail as obtainable in any convenient manner, having a building drum 102 on which the carcass ply or plies 6 coming from a feeding unit 103 are first wound up so as to form a so-called “carcass sleeve” that is substantially cylindrical. Fitted on the end flaps 6a of the carcass ply/plies 6 are the annular anchoring structures 3, so that afterwards turning up of the end flaps themselves is carried out to cause engagement of the anchoring structures in the loops thus formed by the turned-up ply/plies 6. If required, the manufacturing line 101 may comprise devices for associating auxiliary support inserts with the carcass ply or plies 6, which auxiliary inserts are applied during preliminary steps or steps alternated with the steps of laying the ply or plies 6 and/or other components of the carcass structure 2. In particular, application of said auxiliary support inserts 11 or “sidewall inserts” can be provided directly on the building drum 102 before application of the carcass ply or plies 6, or on one of the carcass plies before application of an additional carcass ply 6.

When assembling of the components has been completed, transfer devices not shown pick up the carcass structure 2 from the building drum 102 to transfer it onto a primary drum 104, of the type usually referred to as “shaping drum” for example, to produce the tyre following a manufacturing process of the so-called “two-stage” type.

Alternatively, assembling of the components of the carcass structure 2 can be directly carried out on the primary drum 104, to produce the tyre following a manufacturing process of the so-called “unistage” type.

Simultaneously with assembling of the carcass structure 2 on the building drum 102 or directly on the primary drum 104, the belt structure 7 is made on an auxiliary drum 105. More particularly, to this aim the auxiliary drum 105 is provided to interact with devices 106 for application of the belt structure 7 that can for example comprise at least one feeding unit 107 along which semifinished products in the form of a continuous strip are moved forward, to be then cut into sections of a length corresponding to the extension of the auxiliary drum 105, concurrently with formation of the corresponding belt layers 7a, 7b thereon. Combined with the unit for feeding the belt layers 107 can be a feeding unit for supplying one or more additional reinforcing inserts such as continuous cords (not shown in the drawings) to be applied to the belt layers 7a, 7b so as to form the outer belting layer in the form of axially contiguous circumferential coils.

Upon the action of suitable transfer devices 108, the belt structure 7 disposed on the auxiliary drum 105 lends itself to be picked up from the latter and transferred onto the carcass structure 2 shaped as a cylindrical sleeve and disposed on the primary, drum 104. The transfer devices 108 may comprise a transfer member of substantially annular conformation that is moved until it is disposed around the auxiliary drum 105 to pick up the belt structure 7 therefrom. In a manner known by itself, the auxiliary drum 105 releases the belt structure 7 that is then moved by the transfer member 108 to be placed to a radially external position relative to the primary drum 104 carrying the carcass structure 2 and coaxially centred thereon.

The primary drum 104 can be provided to be picked up from the manufacturing line 101 and transferred to a position suitable for interaction with the transfer member 108 by a suitable laying-down member such as a robotized arm 109. The robotized arm 109 preferably comprises a base 110 rotatable on a fixed platform 111 around a first vertical axis, a first section 112 linked to base 110 in an oscillating manner around a second preferably horizontal axis, a second section 113 linked to the first section 112 in an oscillating manner along a third axis, also preferably horizontal, and a third section 114 rotatably supported by the second section 113 along an axis orthogonal to the third oscillation axis. Linked to the end of the third section 114 of the robotized arm 109 with possibility of oscillation around a fifth and a sixth oscillation axes orthogonal to each other, is a head 115 carrying a motor 116 for rotational driving of the primary drum 104, susceptible of engagement with the head itself in cantilevered fashion.

The robotized arm 109 therefore is adapted to support and control movement of the primary drum 104 or other forming support during the whole production cycle, conveniently positioning it for interaction with the manufacturing line 101 and, subsequently, with the transfer member 108 for the belt structure 7.

The carcass structure 2 coaxially positioned within the belt structure 7 retained by the transfer member 108 is shaped in a toroidal configuration through mutual axial approaching of the annular anchoring structures 3 and simultaneous admission of fluid under pressure into said carcass structure until the carcass ply or plies 6 are brought into contact with the inner surface of the belt structure 7.

Alternatively, the primary drum 104 can consist of a rigid forming support conforming in shape to the inner surface of tyre 1 under production. In this case, manufacture of the carcass structure 2 and the respective belt structure 7 can be directly carried out on the primary drum 104 while the latter is sequentially brought, through the robotized arm 109 or other suitable devices, to interact with one or more work stations located along the manufacturing line 101, to directly form the carcass ply 6, annular anchoring structures 3, belt layers 7a, 7b and/or other constituent elements of tyre 1 through laying of elementary components such as narrow strips of rubberised cords, and/or continuous elongated elements of elastomeric material, as described for example in document U.S. Pat. No. 6,457,504 in the name of the same Applicant.

The structural elements of elastomeric material of tyre 1, such as the tread band 8, under-layer 9, sidewalls 10, auxiliary support inserts 11, said liner, or at least one of them, can be in turn made by winding at least one continuous elongated element 117 of elastomeric material into contiguous circumferential coils, around a forming support that, in the embodiment shown, is represented by the carcass structure 2 in engagement with the primary drum 104 and carrying the respective belt structure 7.

Alternatively, the forming support can consist of the primary drum 104 itself. Said primary drum can be made in the form of a rigid drum conforming in shape to the inner surface extension of tyre 1.

In more detail, the sidewalls 10 can be made directly against the side surfaces of the carcass ply 6. The tread band 8 can be in turn manufactured at a radially external position to the carcass structure 2 and more specifically on the belt structure 7, before or after assembling of the belt structure to the carcass structure 2. Other structural elements such as the liner, possible auxiliary support inserts 11 and/or other structural elements disposed at the inner surfaces of tyre 1, or to be applied to the carcass structure 2 at a second time, can be directly made on the primary drum 104 or other forming support in the form of a rigid drum.

In a preferential embodiment the devices set to associate the structural elements of elastomeric material 8, 9, 10, 11 with the carcass structure 2 comprise at least one unit for manufacturing layered components 118 that, in the embodiment shown, is specifically dedicated to the manufacture of the tread band 8 and the related under-layer 9.

The unit for manufacturing layered components 118 comprises at least one extrusion die 119 communicating with a first extruder 120 and a second extruder 121 or other suitable feeding devices, set to send a first and a second elastomeric materials having different compositions from each other to the extrusion die itself. In the embodiment described, the first elastomeric material is designed and formulated for manufacturing the under-layer 9, whereas the second elastomeric material has a formulation suitable for manufacturing the tread band 8.

As better shown in FIG. 3, die 119 communicates with the first and second extruders 120, 121 through a first and a second inlet channels 122, 123 respectively, that convey the first and second elastomeric materials towards an outflow port 124 arranged in the die itself. The first and second materials flowing through the extrusion die 119 are mutually coupled (FIGS. 4 and 5) so that through the outflow port 124 a first continuous elongated element 117 is delivered that is defined by a first longitudinal portion 125 and a second longitudinal portion 126 disposed close to each other and made up of the first and second elastomeric materials, respectively. In more detail, the outflow port 124 preferably has a perimetral profile of a substantially flattened conformation, the size of greater width of which corresponds to at least 1.5 times the size of smaller width. Correspondingly, the continuous elongated element 117 extruded through the outflow port 124 will have a substantially flattened cross-section profile with a width L at least equal to 1.5 times the thickness H size. As shown in FIGS. 4 and 5, the width L and thickness H of the continuous elongated element 117 correspond to the size of greater width and the size of smaller width respectively of the outflow port 124.

As can be viewed from FIG. 3, the first and second inlet channels 122, 123 converge towards the outflow port 124 at positions that are substantially aligned with each other and parallel to the size of greater width L. Consequently, according to the conformation of the continuous elongated element 117 extruded from the outflow port 124, the first and second longitudinal portions 125, 126 are respectively aligned along a main extension axis Z of the cross-section profile of the elongated element, as shown in FIGS. 4 and 5.

It is also preferably provided that the first and second inlet channels 122, 123 be separated from each other, at the die 119, by means of a partition 127 at a distal position relative to said outflow port 124. Preferably, the partition 127 is substantially disposed in a plane that is inclined to the size of greater width L of the outflow port 124, so that in the continuous elongated element 117 obtained, the first and second longitudinal portions 125, 126 are delimited by an interface line 117a correspondingly inclined to the main extension axis Z, just as an indication according to an angle preferably included between about 15° and about 90°, and more preferably included between about 40° and about 50°.

Alternatively, the first and second longitudinal portions 125, 126 can be provided to be superposed in a direction perpendicular to the main extension axis Z and preferably delimited by an interface line 117a substantially parallel to the main extension axis Z.

The continuous elongated element 117 coming out of the extrusion die 119 is laid on the carcass structure 2 or other forming support 104 in the form of coils wound up following a predetermined path.

To this aim, through the robotized arm 109, the carcass structure 2 carried by the primary drum 103 or other forming support, is positioned in front of the outflow port 124 of the extrusion nozzle 119 and submitted to a circumferential-distribution rotatory motion around a geometric rotation axis X thereof, upon the action of motor 116 or other suitable rotational-driving devices. By effect of this circumferential-distribution rotatory motion the continuous elongated element delivered from the outflow port 124 is suitably distributed, to form the circumferential coils 128 on the forming support 2, 104.

Simultaneously, the different movable sections 112, 113, 114 and/or the head 115 associated with the robotized arm 109, and/or other suitable translational-driving devices, move the forming support 2, 104 in front of the extrusion die 119 through controlled relative displacements of transverse distribution, so that the coils 128 made up of the continuous elongated element 117 are distributed according to a desired path to cause formation of at least one layered component 129 having a first layer 130 and a second layer 131 consisting of the first and second elastomeric materials, respectively.

In more detail, each of the coils 128 formed following laying of the continuous elongated element 117 identifies therealong, a corresponding stretch of the first longitudinal portion 125 coupled with a corresponding stretch of the second longitudinal portion 126. Laying is carried out in such a manner that the consecutive stretches of the first longitudinal portion 125 belonging each to one of the coils 128, are disposed against each other to form the first layer 130 preferably having a thickness included between about 0.2 mm and about 10 mm and more preferably between about 2 mm and about 6 mm. The consecutive stretches of the second longitudinal portion 126, in turn, belonging each to one of the coils 128, are disposed against each other, to form the second layer 131 overlapping the first layer 130.

If the first and second longitudinal portions 125, 126 of the continuous elongated element 117 are superposed at right angles relative to the main extension axis Z, the above described formation of layers 130, 131 can be obtained by disposing the longitudinal element itself in such a manner that, during formation of each coil 128, the main extension axis Z is substantially parallel to a plane tangent to the surface of the forming support 2, 104, at the laying point of the elongated element itself.

If, on the contrary, as in the example shown in FIGS. 4 and 5, the first and second longitudinal portions 125, 126 of the continuous elongated element 117 are aligned in parallel relationship with the main axis Z, each of the coils 128 is provided to partly overlap the previously formed coil, except for laying of the first coil, so that the second longitudinal portion 126 of the elongated element, in the stretch belonging to each coil 128, is superposed relative to the first longitudinal portion 125. The first longitudinal portion 125 in turn will be at least partly interposed between the forming support 2, 104 and the second longitudinal portion 126 of the continuous elongated element 117.

Therefore it is advantageously possible to manufacture, in a single operation, a first structural element represented by the first layer 130, together with at least one portion of a second structural element represented by the second layer 131. In the described example and with reference to the accompanying drawings, the first and second structural elements are represented by the under-layer 9 and tread band 8 respectively, that are directly made at a radially external position to the carcass structure 2 and more specifically on the belt structure 7, before or after associating said belt structure with the remaining parts of the carcass structure 2.

If required, the first layer 130 can advantageously have a very reduced thickness, even smaller than 0.5 mm, without involving complications in the correct laying of the continuous elongated element 117. In fact, even if the first longitudinal portion 125 designed to form the first layer 130 has small sizes, the presence of the second longitudinal portion 126 coupled therewith enables a continuous and uniform dragging along of the first longitudinal portion emerging from die 119 and ensures a structural consistency to the continuous elongated element as a whole, which is suitable for correct laying on the forming support.

If required, the first and/or second extruders 120, 121 can be equipped with control devices, not further described or illustrated as they can be made in any convenient manner, which for example enable the operation speed of the extruders themselves to be modified and/or the amount of the elastomeric material sent into the die 119 to be partly reduced so as to suitably modulate delivery of the first and/or second elastomeric material at the exit. Thus it is possible to obtain thickness variations in the first and/or second layers 130, 131 during delivery, or to keep the thickness of the obtained layered components to a predetermined constant value, or also to make structural elements of variable thickness.

In case of need, the control devices can also disable delivery of the first and/or second material thereby allowing delivery of a continuous elongated element 117 made of a single material. This also enables manufacture of layered components 129 in which the first and/or second layer 130, 131 have an interrupted and/or alternated extension.

If required, at least one covering layer 132 of elastomeric material can be applied to the layered component 129, said covering layer preferably having the same composition as the second layer 131 of the layered component that will be interposed between the first layer 130 and the covering layer itself.

This solution is particularly advantageous when the second layer 131 of the layered component 129 must only constitute part of the structural element coupled with the first layer 130.

In the embodiment shown, the covering layer 132 is formed by a first auxiliary unit 133 comprising a third extruder 134 or equivalent devices designed to deliver a second continuous elongated element (not shown) onto the layered component 129 previously formed on the carcass structure 2, or other forming support that, through the robotized arm 109, is brought in front of the auxiliary unit itself and suitably driven in rotation and moved in front of the latter so that the second continuous elongated element is distributed into coils wound up according to a predetermined path. Thus the covering layer 132 is obtained, which layer in the embodiment herein shown, together with the second layer 131 of the layered component 129 forms the tread band 8.

As an alternative to the above description, the covering layer 132 can be prepared as a semifinished product in the form of a continuous strip of a length corresponding to the circumferential extension of the layered component 129. In this case, the auxiliary unit 133 will be provided with devices for winding the strip of elastomeric material on the layered component 129 and for mutually joining the opposite ends of the strip wound up on said layered component 129, in a manner known by itself.

It is to be pointed out that the auxiliary unit 133 utilised for manufacturing the covering layer 132 will require a lower productivity than that usually needed in the known art for the units dedicated to the manufacture of the whole tread band 8.

In addition to, or in place of the first auxiliary unit 133, a second auxiliary unit (not shown) can be provided, said unit being designed to apply at least one base layer of elastomeric material to the carcass structure 2 or other forming support, said base layer being interposed between the forming support itself and the first layer 130 of the layered component 129, subsequently formed on the base layer. In the same manner as described with reference to the first auxiliary unit 133, this second auxiliary unit too may comprise a respective extruder or similar devices, to deliver a third continuous elongated element disposed in a manner adapted to form coils wound up in a predetermined path on the carcass structure 2 or other forming support positioned and suitably moved in front of the auxiliary unit itself by means of the robotized arm 109 or other handling devices.

Alternatively, the second auxiliary unit may comprise devices designed to arrange a semifinished product of elastomeric material in the form of a strip of a length corresponding to the circumferential extension of the carcass structure 2 or other forming support, then winding this strip on the forming support and subsequently joining the opposite ends of the strip wound up on said forming support.

The base layer can be made of the same material as, or a material compatible with, the material forming the first layer 130 that will be interposed between the base layer itself and the second layer 131 of the layered component 129. In case of need, this enables the obtainable thickness of the first layer 130 in the layered component 129 to be increased and/or the layered component 129 to be coupled with any different structural element constituting the base layer.

In addition to, or in place of formation of the tread band 8 and respective under-layer 9, the above described unit 118 for manufacturing layered components can be designed for manufacturing the sidewalls 10, possible auxiliary support inserts 11, said liner and/or any other structural element of elastomeric material of the tyre 1 under working.

In more detail, operation of the robotized arm 109 and of unit 118 for manufacturing layered components, or a similar unit combined with apparatus 1, may be provided to be co-ordinated so as to cause formation of the continuous elongated element 117 laterally against the carcass structure 2, the obtained layered component 129 thereby constituting at least part of the sidewall 10 of tyre 1. Thus, sidewalls 10 made up of two or more portions consisting of different elastomeric materials can be manufactured.

In addition or as an alternative to the above, operation of unit 118 for manufacturing layered components and of the robotized arm 109 can be co-ordinated so as to carry out laying of the continuous elongated element 117 at an axially external position to the forming support, before or after application of the carcass structure 2, to manufacture possible auxiliary support inserts 11 that, after the carcass structure 2 is disposed on the forming support, will appear to be laterally applied, at the inside or outside of the carcass ply 6.

Likewise, a unit 118 for manufacturing layered components can be used to make a liner in combination with a so-called under-liner and/or at least part of the possible auxiliary support inserts 11 or other structural elements of tyre 1, to be set internally of the carcass structure 2.

When manufacture of the tread band 8 and sidewalls 10 has been completed, the robotized arm 109 carries out a new translation of the primary drum 104 to position it in front of devices that, if required, disengage the assembled tyre 1 from said primary drum 140 and transfer it into a mould or other devices used for carrying out a moulding and curing step on the tyre itself.

It will be recognised that the invention can be also advantageously utilised, with the aid of the unit for forming layered components of the above described type, for making manufactured articles different from tyres for motor-vehicles. In particular, the invention can be for example used for making layered elements such as expandable bladders of the type currently used in vulcanisation apparatus and/or inflatable bags used in apparatus for manufacturing the tyres themselves.

1-78. (canceled)

79. A method of manufacturing a tyre for vehicle wheels, comprising the steps of:
forming a carcass structure comprising elongated reinforcing elements incorporated in an elastomer matrix;
associating structural elements of elastomeric material with said carcass structure, wherein the step of associating the structural elements of elastomeric material with the carcass structure comprises preparation of at least one layered component by the steps of:
conveying a first and a second elastomeric materials toward an extrusion die;
coupling the first and second elastomeric materials through said extrusion die to deliver a first continuous elongated element defined by a first longitudinal portion and a second longitudinal portion disposed in side by side relationship and made up of said first and said second elastomeric materials, respectively;
laying said continuous elongated element on a forming support in the form of coils wound up according to a predetermined path, so as to form said layered component having a first layer and a second layer consisting of said first and second elastomeric materials, respectively; and
curing the tyre.

80. The method as claimed in claim 79, wherein the continuous elongated element is shaped so as to have a substantially flattened cross-section profile.

81. The method as claimed in claim 80, wherein said cross section has a conformation involving a size in width equal to at least 1.5 times the thickness size.

82. The method as claimed in claim 80, wherein the continuous elongated element is shaped to have said first and second longitudinal portions respectively aligned along a main extension axis of the cross-section profile of the continuous elongated element.

83. The method as claimed in claim 79, wherein the continuous elongated element is laid on the forming support with a main extension axis of its cross-section profile substantially parallel to a plane tangent to a surface of the forming support at a laying point of the elongated element.

84. The method as claimed in claim 79, wherein, in the laying step, the first longitudinal portion of the continuous elongated element is at least partly interposed between the forming support and the second longitudinal portion of the continuous elongated element.

85. The method as claimed in claim 79, further comprising the step of modulating delivery of at least one of said first and second materials at the exit of the die so as to cause a variation in thickness of one of said first and second layers relative to the other layer.

86. The method as claimed in claim 79, further comprising the step of selectively disabling delivery of one of said first and second materials at the exit of the die so as to cause an interruption in the extension of the corresponding first or second layers in the layered component.

87. The method as claimed in claim 79, wherein conveying of the first and second elastomeric materials is carried out by a first and a second extruder, respectively.

88. The method as claimed in claim 79, wherein laying of the continuous elongated element comprises the steps of:
positioning the forming support adjacent to the extrusion die;
giving the forming support a circumferential-distribution rotatory motion around a geometric rotation axis so that the continuous elongated element delivered from the extrusion die is circumferentially distributed on the forming support; and
carrying out controlled relative displacements for transverse distribution between the forming support and the extrusion die so as to form said coils.

89. The method as claimed in claim 79, further comprising the step of applying at least one covering layer of elastomeric material onto said layered component, the second layer of the layered component being interposed between said first layer and the covering layer.

90. The method as claimed in claim 89, wherein the covering layer is formed by the steps of:
delivering a second continuous elongated element; and
laying said second continuous elongated element on the layered component by means of coils wound up according to a predetermined path, so as to form said covering layer.

91. The method as claimed in claim 89, wherein the second continuous elongated element is extruded from an extruder simultaneously with laying the second continuous elongated element on the layered component.

92. The method as claimed in claim 89, wherein the covering layer is formed by the steps of:
forming a strip of elastomeric material of a length corresponding to the circumferential extension of the layered component;
winding the strip of elastomeric material on the layered component; and
mutually joining the opposite ends of the strip wound on the layered component.

93. The method as claimed in claim 89, wherein the covering layer is made of said second elastomeric material.

94. The method as claimed in claim 79, comprising the step of applying at least one base layer of elastomeric material onto the forming support, the first layer of the layered component being interposed between the second layer and the base layer before formation of the layered component.

95. The method as claimed in claim 94, wherein the base component is formed by the steps of:
delivering a third continuous elongated element; and
laying said third continuous elongated element on the forming support by means of coils wound according to a predetermined path so as to form said base layer.

96. The method as claimed in claim 95, wherein the third continuous elongated element is delivered from a respective extruder simultaneously with laying of same on the forming support.

97. The method as claimed in claim 94, wherein the base layer is formed by the steps of:
forming a strip of elastomeric material of a length corresponding to the extension of the forming support;
winding the strip of elastomeric material on the forming support; and
mutually joining the opposite ends of the strip wound up on the forming support.

98. The method as claimed in claim 94, wherein the base layer is made of said first elastomeric material.

99. The method as claimed in claim 79, wherein laying of the first continuous elongated element is carried out at a radially external position to the carcass structure previously set on the forming support so as to form a layered component of a tread band of said tyre.

100. The method as claimed in claim 79, further comprising the steps of setting a belt structure and associating said belt structure with the carcass structure, wherein laying of the continuous elongated element is carried out at a radially external position to said belt structure before or after associating the belt structure with the carcass structure so as to form a layered component of a tread band of said tyre.

101. The method as claimed in claim 79, wherein laying of the continuous elongated element is carried out laterally against the carcass structure so as to form a layered component of a sidewall of said tyre.

102. A method as claimed in claim 79, wherein laying of the continuous elongated element is carried out at an axially external position to the forming support so as to form a layered component of an auxiliary support insert before disposing the carcass structure on the forming support for applying said auxiliary support insert laterally at the inside of the carcass structure.

103. The method as claimed in claim 79, wherein in said laying step, consecutive sections of the first longitudinal portion of the continuous elongated element belonging each to one of the coils are disposed against each other to form the first layer, and consecutive sections of the second longitudinal portion belonging each to one of the coils are disposed against each other to form the second layer overlapping the first layer.

104. The method as claimed in claim 79, wherein the first layer has a thickness of about 0.2 mm to about 10 mm.

105. The method as claimed in claim 104, wherein said thickness is about 2 mm to about 6 mm.

106. The method as claimed in claim 79, wherein said first and second longitudinal portions are delimited by an interface line forming an angle relative to a main extension axis of the cross-section profile of said continuous elongated element that is about 15° to about 90°.

107. The method as claimed in claim 106, wherein said angle is about 40° to about 50°.

108. A method of forming a layered element of elastomeric material, comprising the steps of:
conveying a first and a second elastomeric materials toward an extrusion die;
delivering the first and second elastomeric materials through said extrusion die for obtaining a continuous elongated element defined by a first longitudinal portion and a second longitudinal portion disposed in side by side relationship and made up of a first and a second elastomeric materials, respectively;
laying said continuous elongated element on a forming support in the form of coils wound according to a predetermined path so as to form said layered element having a first layer and a second layer made of said first and said second elastomeric materials, respectively, wherein said first layer has a thickness of about 0.2 mm to about 10 mm.

109. The method as claimed in claim 108, wherein the continuous elongated element has a substantially flattened cross-section profile.

110. The method as claimed in claim 109, wherein said cross section has a conformation of a size in width equal to at least 1.5 times the thickness.

111. The method as claimed in claim 109, wherein the continuous elongated element comprises a shape such that said first and second longitudinal portions, respectively, are aligned along a main extension axis of a cross-section profile of the continuous elongated element.

112. The method as claimed in claim 108, wherein the continuous elongated element is laid on the forming support with a main extension axis of its cross-section profile substantially parallel to a plane tangent to a surface of the forming support at a laying point of the elongated element.

113. The method as claimed in claim 108, wherein, in the laying step, the first longitudinal portion of the continuous elongated element is at least partly interposed between the forming support and the second longitudinal portion of the continuous elongated element.

114. The method as claimed in claim 108, further comprising the step of modulating delivery of at least one of said first and second materials at the exit of the die so as to cause a variation in thickness of one of said first and second layers relative to the other layer.

115. The method as claimed in claim 108, further comprising the step of selectively disabling delivery of one of said first and second materials at the exit of the die so as to cause an interruption in the extension of the corresponding first or second layers in the layered element.

116. The method as claimed in claim 108, wherein conveying of the first and second elastomeric materials is carried out by a first and a second extruder, respectively.

117. The method as claimed in claim 108, wherein laying of the continuous elongated element comprises the steps of:
positioning the forming support adjacent to the extrusion die;
giving the forming support a circumferential-distribution rotatory motion around a geometric rotation axis so that the continuous elongated element delivered from the extrusion die is circumferentially distributed on the forming support; and
carrying out controlled relative displacements for transverse distribution between the forming support and the extrusion die so as to form said coils.

118. The method as claimed in claim 108, further comprising the step of applying at least one covering layer of elastomeric material onto said layered element, said second layer being interposed between said first layer and the covering layer.

119. The method as claimed in claim 108, wherein, before formation of the layered element, the step of applying at least one base layer of elastomeric material onto the forming support; said first layer being interposed between the second layer and the base layer.

120. The method as claimed in claim 108, wherein, in said laying step, consecutive sections of the first longitudinal portion of the continuous elongated element, each consecutive section belonging to one of the coils, are disposed against each other to form the first layer and consecutive sections of the second longitudinal portion, each belonging to one of the coils, are disposed against each other to form the second layer overlapping the first layer.

121. The method as claimed in claim 108, wherein said thickness of the first layer is about 2 mm to about 6 mm.

122. The method as claimed in claim 108, wherein said first and second longitudinal portions are delimited by an interface line forming an angle relative to a main extension axis of the cross-section profile of said continuous elongated element of about 15° to about 90°.

123. The method as claimed in claim 122, wherein said angle is about 40° to about 50°.

124. An apparatus for manufacturing tyres for vehicle wheels, comprising:
devices designed to form a carcass structure comprising elongated reinforcing elements incorporated into an elastomer matrix;
devices for associating structural elements of elastomeric materials with said carcass structure;
devices for curing said tyre, wherein the devices for associating the structural elements of elastomeric material with the carcass structure comprise at least one unit for manufacturing layered components, comprising:
first devices for feeding a first elastomeric material;
second devices for feeding a second elastomeric material;
an extrusion die communicating with said first and second feeding devices to deliver a first continuous elongated element from an outflow port, said first continuous elongated element being defined by a first elongated portion and a second longitudinal portion disposed in side by side relationship and made up of said first and second elastomeric materials, respectively; and
members for laying said continuous elongated element into coils wound according to a predetermined path on a forming support so as to form a layered component having a first layer and a second layer consisting of said first and second elastomeric materials, respectively.

125. The apparatus as claimed in claim 124, wherein said outflow port has a substantially flattened conformation.

126. The apparatus as claimed in claim 125, wherein the outflow port has a size of greater width corresponding to at least 1.5 times a size of the same of smaller width.

127. The apparatus as claimed in claim 125, wherein the extrusion die comprises:
a first inlet channel communicating with the first feeding devices; and
a second inlet channel communicating with the second feeding devices,
wherein the first and second inlet channels converge toward the outflow port at mutually aligned positions parallel to a main extension axis of the outflow port.

128. The apparatus as claimed in claim 124, further comprising devices for modulating delivery of at least one of said first and second elastomeric materials at the exit of the die to cause variations in the thickness of one of said first and second layers relative to the other layer.

129. The apparatus as claimed in claim 124, further comprising devices for selectively disabling delivery of one of said first and second materials coming out of the die to cause an interruption in the extension of the corresponding first or second layers in the layered component.

130. The apparatus as claimed in claim 124, wherein said first feeding device and second feeding device comprise a first and a second extruder, respectively.

131. The apparatus as claimed in claim 124, wherein said unit for manufacturing layered components comprises:
rotational-driving devices to give the forming support a circumferential-distribution rotatory motion around a geometric rotation axis so that the continuous elongated element delivered from the extrusion die is circumferentially distributed on the forming support; and
translational-driving devices to carry out controlled relative displacements for transverse distribution between the forming support and the extrusion die so as to form said coils.

132. The apparatus as claimed in claim 124, further comprising a first auxiliary unit to apply at least one covering layer of elastomeric material onto said layered component, the second layer of the layered component being interposed between the first layer and the covering layer.

133. The apparatus as claimed in claim 132, wherein said first auxiliary unit comprises:
devices for delivering a second continuous elongated element; and
devices for laying said second continuous elongated element on said layered component by means of coils wound according to a predetermined path, so as to form said covering layer.

134. The apparatus as claimed in claim 133, wherein the devices for delivering the second continuous elongated element comprise a third extruder.

135. The apparatus as claimed in claim 132, wherein said first auxiliary unit comprises:
devices for setting a strip of elastomeric material of a length corresponding to the extension of the layered component;
devices for winding the strip of elastomeric material on the layered component; and
devices for mutually joining the opposite ends of the strip wound up on the layered component.

136. The apparatus as claimed in claim 124, further comprising a second auxiliary unit for applying at least one base layer of elastomeric material onto the forming support before formation of the layered component.

137. The apparatus as claimed in claim 136, wherein said second auxiliary unit comprises:
devices for delivering a third continuous elongated element; and
devices for laying said third continuous elongated element on the forming support by means of coils wound up according to a predetermined path so as to form said base layer.

138. The apparatus as claimed in claim 137, wherein the devices for delivering the third continuous elongated element comprise a fourth extruder.

139. The apparatus as claimed in claim 136, wherein said second auxiliary unit comprises:
devices for setting a strip of elastomeric material of a length corresponding to the extension of the forming support;
devices for winding the strip of elastomeric material on the forming support; and
devices for mutually joining the opposite ends of the strip wound up on the forming support.

140. The apparatus as claimed in claim 124, wherein said at least one unit for manufacturing layered components is designed to make tread bands at a radially external position to the carcass structure.

141. The apparatus as claimed in claim 124, further comprising devices for manufacturing a belt structure and devices for associating said belt structure with the carcass structure at a radially external position, wherein said at least one unit for manufacturing layered components is designed to make a tread band at a radially external position to said belt structure.

142. The apparatus as claimed in claim 124, wherein said at least one unit for manufacturing layered components is designed to make sidewalls laterally disposed against the carcass structure.

143. The apparatus as claimed in claim 124, wherein said at least one unit for manufacturing layered components is designed to make auxiliary support inserts to be associated with the carcass structure.

144. The apparatus as claimed in claim 124, wherein upon the action of laying-down members, consecutive sections of the first longitudinal portion of the continuous elongated element belonging each to one of the coils, are disposed against each other to form the first layer, and consecutive sections of the second longitudinal portion belonging each to one of the coils are disposed against each other to form the second layer overlapping the first layer.

145. The apparatus as claimed in claim 124, wherein the extrusion die is provided with:
a first inlet channel communicating with the first feeding devices; and
a second inlet channel communicating with the second feeding devices, wherein the first and second inlet channels converge toward the outflow port, said first and second inlet channels being respectively separated in correspondence with said die at a distal position relative to said outflow port by a partition.

146. An apparatus designed to form layered elements of elastomeric material, comprising:
first devices for feeding a first elastomeric material;
second devices for feeding a second elastomeric material;
an extrusion die comprising:
a first inlet channel communicating with the first feeding devices; and
a second inlet channel communicating with the second devices,
said first and second inlet channels flowing into an outflow port to deliver a continuous elongated element defined by a first longitudinal portion and a second longitudinal portion disposed in side by side relationship and made up of said first and second elastomeric materials, respectively, said first and second inlet channels being separated from each other in correspondence with said extrusion die at a distal position relative to said outflow port by means of a partition; and
members for laying said continuous elongated element on a forming support by means of coils wound according to a predetermined path so as to form said layered element having a first layer and a second layer consisting of said first and second elastomeric materials, respectively.

147. The apparatus as claimed in claim 146, wherein said outflow portion has a substantially flattened conformation.

148. The apparatus as claimed in claim 146, wherein the outflow portion has one size of greater width corresponding to at least 1.5 times a size of the same of smaller width.

149. The apparatus as claimed in claim 146, wherein said first and second inlet channels flow into the outflow port at respectively aligned positions in a direction substantially parallel to a main extension axis of the outflow port.

150. The apparatus as claimed in claim 146, further comprising devices for modulating delivery of at least one of said first and second materials at the exit of the die to cause variations in the thickness of one of said first and second layers relative to the other layer.

151. The apparatus as claimed n claim 146, further comprising devices for selectively disabling delivery of one of said first and second materials coming out of the die to cause an interruption in the extension of the corresponding first or second layers in the layered element.

152. The apparatus as claimed in claim 146, wherein said first feeding device and second feeding device comprise a first and a second extruder, respectively.

153. The apparatus as claimed in claim 146, wherein said unit for manufacturing layered elements comprises:
rotational-driving devices to give the forming support a circumferential-distribution rotatory motion around a geometric rotation axis so that the continuous elongated element delivered from the extrusion die is circumferentially distributed on the forming support; and
translational-driving devices for carrying out controlled relative displacements for transverse distribution between the forming support and the extrusion die so as to form said coils.

154. The apparatus as claimed in claim 146, further comprising a first auxiliary unit for application of at least one covering layer of elastomeric material onto said layered element, the second layer of the layered element being interposed between the first layer and the covering layer.

155. The apparatus as claimed in claim 146, further comprising a second auxiliary unit for application of at least one base layer of elastomeric material onto the forming support before formation of the layered element.

156. The apparatus as claimed in claim 146, wherein, upon the action of laying-down members, consecutive sections of the first longitudinal portion of the continuous elongated element belonging each to one of the coils, are disposed against each other to form the first layer, and consecutive sections of the second longitudinal portion belonging each to one of the coils, are disposed against each other to form the second layer overlapping the first layer.
